(19) United States
(12) Patent Application Publication
(10) Pub. No.: US 2026/0199838 A1
(43) Pub. Date: Jul. 16, 2026

(54) REVERSE OSMOSIS (RO) WATER FILTRATION SYSTEM FOR RECREATIONAL VEHICLES (RVs) AND METHOD OF WATER PURIFICATION AND DISPENSATION

(71) Applicant: Jorge Pancorvo, Midlothian, TX (US)

(72) Inventor: Jorge Pancorvo, Midlothian, TX (US)

(21) Appl. No.: 19/021,953

(22) Filed: Jan. 15, 2025

(51) Int. Cl. B01D 61/08; B01D 61/02; B01D 61/12; C02F 1/44; C02F 101/12

(52) U.S. Cl. CPC B01D 61/081; B01D 61/026; B01D 61/12; C02F 1/441; B01D 2313/105; B01D 2313/12; B01D 2313/131; B01D 2313/18; B01D 2313/19; B01D 2313/501; C02F 2101/12; C02F 2201/004; C02F 2201/005; C02F 2201/008; C02F 2209/40; C02F 2301/08; C02F 2303/14

(57) ABSTRACT

Disclosed is a reverse osmosis (RO) water filtration system specifically designed for use in recreational vehicles (RVs). The system includes an RO manifold that houses multiple filtration stages, ensuring thorough purification of water. A dual faucet connection allows seamless integration with an RV's external water source. The system also features a water storage tank that pressurizes the manifold for quick dispensing of purified water, while colored tubing provides distinct pathways for water distribution. Additional components include a quick connect adaptor, a flow restrictor to optimize filtration efficiency, a water line shut-off valve for flow control, and a water storage dispenser for convenient access to drinking water. The design also includes a storage valve to isolate the water tank for easy maintenance. This system offers a comprehensive, efficient, and user-friendly solution for ensuring clean drinking water in RVs.

### TECHNICAL FIELD

The presently disclosed embodiments are related, in general, to a recreational vehicle (RV) reverse osmosis (RO) water filtration and drinking water system. More particularly, the presently disclosed embodiments are related to reverse osmosis (RO) water filtration systems for recreational vehicles (RVs) and methods of water purification and dispensation.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Reverse osmosis (RO) systems have been widely used for decades to purify water by removing contaminants through a semipermeable membrane. These systems are commonly installed in residential, commercial, and industrial settings to provide clean drinking water. However, traditional RO systems have not been specifically designed for use in recreational vehicles (RVs) or motor homes, where space constraints, portability, and ease of installation are critical considerations.

Despite the growing popularity of RVs and the need for clean water during travel, there has been a lack of RO systems tailored for installation in these vehicles. The unique requirements of RVs, such as the ability to connect to various water sources at different locations and operate effectively under varying pressure conditions, have not been adequately addressed by existing RO systems.

The present invention addresses the aforementioned issues by providing a reverse osmosis water filtration system specifically designed for use in RVs and motor homes.

Thus, in view of the above, there is a long-felt need in the industry to address the aforementioned deficiencies and inadequacies.

Further limitations and disadvantages of traditional approaches will become apparent to one of skill in the art, through the comparison of described systems with some aspects of the present disclosure, as set forth in the remainder of the present application and with reference to the drawings.

### SUMMARY

A reverse osmosis (RO) water filtration system for recreational vehicles (RVs) and method of water purification and dispensation are provided substantially, as shown in and/or described in connection with at least one of the figures.

An aspect of the present disclosure relates to a reverse osmosis (RO) water filtration system for use with a recreational vehicle (RV). The RO water filtration system includes a RO manifold, a dual faucet connection, a water storage tank, a colored tubing, a RO tank storage valve, a quick connect adaptor, a water storage dispenser, a flow restrictor, and a water line shut-off valve. The RO manifold is configured as a base unit housing a plurality of multiple filtration stages of a reverse osmosis process and dispensing purified water to one or more components of the RO water filtration system. The dual faucet connection is configured to connect the RV's water line from an external site's water source to the RO manifold. The water storage tank is configured to store water purified by the RO manifold and pressurize the RO manifold for rapid dispensing. The colored tubing is configured to provide distinct channels for distributing and receiving water from and to the components of the RO water filtration system. The RO tank storage valve is configured to allow the water storage tank to be isolated from the RO water filtration system for disassembly or maintenance. The quick connect adaptor is configured to facilitate the connection of the water line from the RO water filtration system to the dual faucet connection. The water storage dispenser is configured for the convenient dispensing of purified water directly into a container for drinking. The flow restrictor is configured to regulate and slow the outflow of water exiting the RO water filtration system via a waste line, optimizing the efficiency of the filtration process. The water line shut-off valve is configured to provide control over the flow of water into or out of the RO manifold on a specific water line.

In an aspect, the RO manifold includes multiple filtration stages, each configured to remove specific types of contaminants from the water, including sediments, chlorine, and dissolved solids.

In an aspect, the water storage tank is pressurized to maintain a constant supply of purified water for immediate use without requiring additional pumping.

In an aspect, the colored tubing includes color-coded connections to simplify the installation and maintenance process by clearly indicating the pathways for water inflow, purified water outflow, and wastewater exit.

In an aspect, the RO tank storage valve is configured to be manually operated, allowing users to easily isolate the water storage tank for maintenance or disassembly.

In an aspect, the quick connect adaptor is designed for tool-free connection and disconnection of the water lines, enhancing the ease of setup and use within the RV environment.

In an aspect, the water storage dispenser is integrated into the RV's kitchen or living area, allowing for convenient access to purified drinking water.

In an aspect, the flow restrictor is adjustable and enables users to fine-tune the wastewater output to optimize water conservation during the filtration process.

In an aspect, the water line shut-off valve is a manual valve that allows for the selective control of water flow to specific components within the RO system, such as the storage tank or dispenser.

Another aspect of the present disclosure relates to a method for purifying water in a recreational vehicle (RV) using a reverse osmosis (RO) water filtration system. The method includes a step of connecting the RV's water line from an external water source to a RO manifold using a dual faucet connection. The method includes a step of routing the water through the RO manifold where the RO manifold undergoes multiple stages of filtration to remove contaminants. The method includes a step of storing the purified water in a pressurized water storage tank connected to the RO manifold. The method includes a step of distributing the purified water through colored tubing to various outlets within the RV, including a water storage dispenser for direct use. The method includes a step of regulating the flow of wastewater exiting the RO water filtration system via a flow restrictor to optimize the efficiency of the filtration process. The method includes a step of using a water line shut-off valve to control the flow of water into and out of the RO manifold and the water storage tank as needed. The method includes a step of isolating the water storage tank by operating an RO tank storage valve to facilitate the maintenance or disassembly of one or more components of the RO water filtration system.

In an aspect, the step of connecting the RV's water line includes a step of using a quick connect adaptor to simplify the connection and disconnection process.

In an aspect, the method includes a step of performing routine maintenance by isolating the water storage tank and removing it from the system for cleaning, facilitated by the operation of the RO tank storage valve.

In an aspect, the method includes a step of dispensing the purified water from the storage dispenser into a cup or container for drinking, utilizing the pressure maintained in the water storage tank.

In an aspect, the regulation of the wastewater flow via the flow restrictor includes adjusting the flow restrictor to balance water conservation with optimal filtration performance.

One advantage of the present invention is that it is easy to connect and can be used with potable water provided by an RV camp, allowing seamless integration with the RV RO system. The present reverse osmosis (RO) water filtration system is designed for use in any RV or motorhome at docking spots or any other location with potable water and a pressure of 30 PSI or higher.

Accordingly, one advantage of the present invention is that it is engineered for easy installation, offering a convenient and reliable solution for travelers seeking purified water on the go.

These and other features and advantages of the present disclosure may be appreciated from a review of the following detailed description of the present disclosure, along with the accompanying figures in which reference numerals refer to like parts throughout.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a perspective view of a RO manifold, in accordance with at least one embodiment.

FIG. 2 is a perspective view of a dual faucet connection, in accordance with at least one embodiment.

FIG. 3 is a perspective view of a water storage tank, in accordance with at least one embodiment.

FIG. 4 is a perspective view of a colored tubing, in accordance with at least one embodiment.

FIG. 5 is a perspective view of a RO tank storage valve, in accordance with at least one embodiment.

FIG. 6 is a perspective view of a water storage dispenser, in accordance with at least one embodiment.

FIG. 7 is a perspective view of a flow restrictor, in accordance with at least one embodiment.

FIG. 8 is a perspective view of a water line shut-off valve, in accordance with at least one embodiment.

FIG. 9 is a perspective view of a security strap, in accordance with at least one embodiment.

FIG. 10 is a perspective view of a screw, in accordance with at least one embodiment.

FIG. 11 is a flowchart of a method for purifying water in a recreational vehicle (RV) using a reverse osmosis (RO) water filtration system, in accordance with at least one embodiment.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the apparatuses, methods, and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

The present disclosure is about a reverse osmosis (RO) water filtration system for use with a recreational vehicle (RV). The present reverse osmosis (RO) water filtration system is uniquely designed to be the first of its kind for use in any RV or motor home, whether at a docking spot or any location with potable water and a minimum pressure of 30 PSI. The system features an easy connection process, utilizing the potable water provided at RV camps to link directly to the RV RO system. It efficiently fills either a pressure tank or the provided RO container, and is equipped with a floater device that automatically shuts off when full. Alternatively, users can opt to use two ports on the RV RO system to simultaneously fill two tanks, each with a capacity of two gallons (optional). The water produced by this system is of the highest quality, with a TDS (Total Dissolved Solids) range of 0-30, depending on the quality of water available at the RV camp or site. The system includes all necessary receptacles, fittings, and connections, color-coded for ease of installation. Additional tanks and pressure tanks can be added at an extra cost, and the quick-connect cartridges allow for easy replacement without the need for de-installation and reinstallation of the RV RO system.

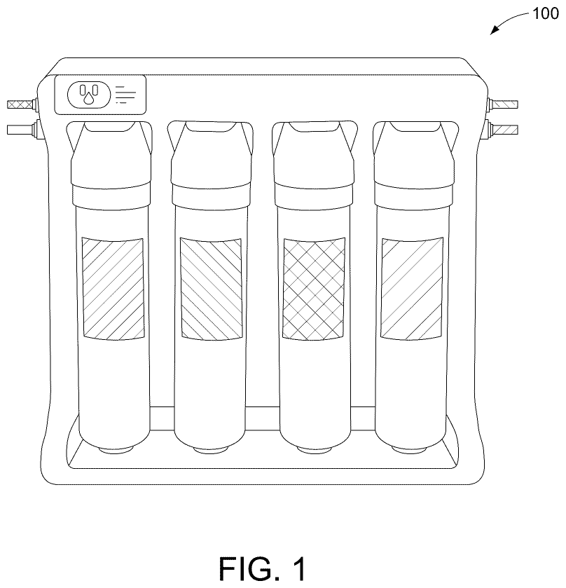

The RO water filtration system includes a RO manifold 100, a dual faucet connection 200, a water storage tank 300, colored tubing 400, a RO tank storage valve 500, a quick connect adaptor (not shown), a water storage dispenser 600, a flow restrictor 700, a water line shut-off valve 800, a security strap 900, and various screws 1000. FIG. 1-FIG. 10 are explained in conjunction with each other. FIG. 1 is a perspective view of a RO manifold 100, in accordance with at least one embodiment. In an embodiment, the RO manifold 100 includes multiple filtration stages, each configured to remove specific types of contaminants from the water, including sediments, chlorine, and dissolved solids. The RO manifold 100 is configured as a base unit housing a plurality of multiple filtration stages of a reverse osmosis process and dispensing purified water to one or more components of the RO water filtration system.

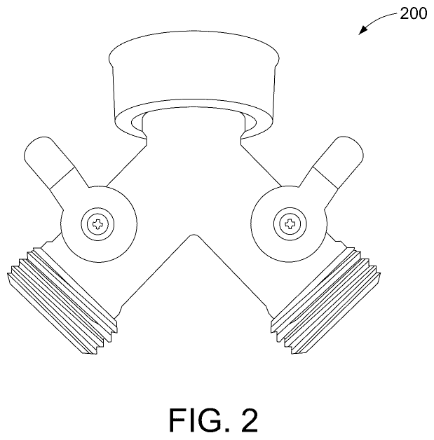

FIG. 2 is a perspective view of a dual faucet connection 200, in accordance with at least one embodiment. The dual faucet connection 200 is configured to connect the RV's water line from an external site's water source to the RO manifold 100.

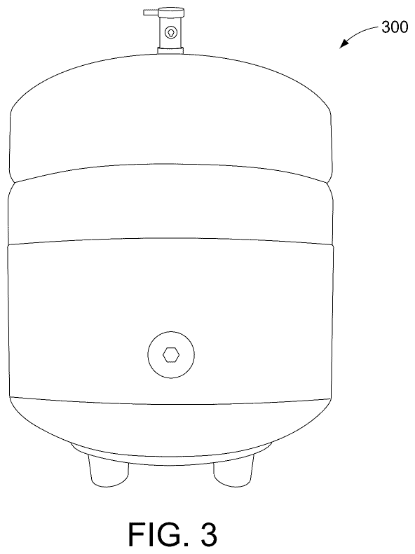

FIG. 3 is a perspective view of a water storage tank 300, in accordance with at least one embodiment. The water storage tank 300 is configured to store water purified by the RO manifold 100 and pressurize the RO manifold 100 for rapid dispensing. In an embodiment, the water storage tank 300 is pressurized to maintain a constant supply of purified water for immediate use without requiring additional pumping.

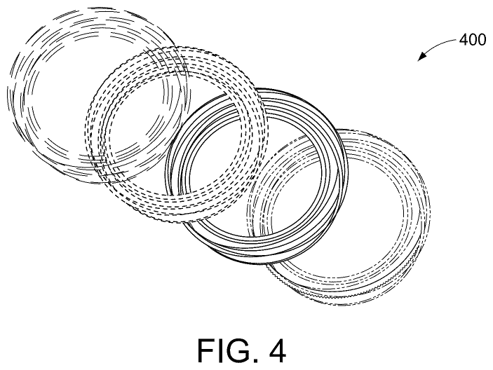

FIG. 4 is a perspective view of colored tubing 400, in accordance with at least one embodiment. The colored tubing 400 is configured to provide distinct channels for distributing and receiving water from and to the components of the RO water filtration system. In an embodiment, the colored tubing 400 includes color-coded connections to simplify the installation and maintenance process by clearly indicating the pathways for water inflow, purified water outflow, and wastewater exit.

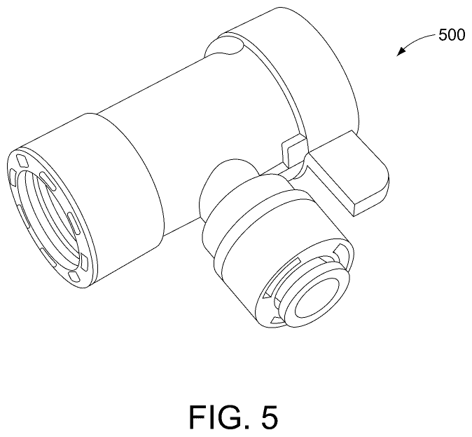

FIG. 5 is a perspective view of an RO tank storage valve 500, in accordance with at least one embodiment. The RO tank storage valve 500 is configured to allow the water storage tank 300 to be isolated from the RO water filtration system for disassembly or maintenance. In an embodiment, the RO tank storage valve 500 is configured to be manually operated, allowing users to easily isolate the water storage tank for maintenance or disassembly. The quick connect adaptor is configured to facilitate the connection of the water line from the RO water filtration system to the dual faucet connection 200. In an embodiment, the quick connect adaptor is designed for tool-free connection and disconnection of the water lines, enhancing the ease of setup and use within the RV environment.

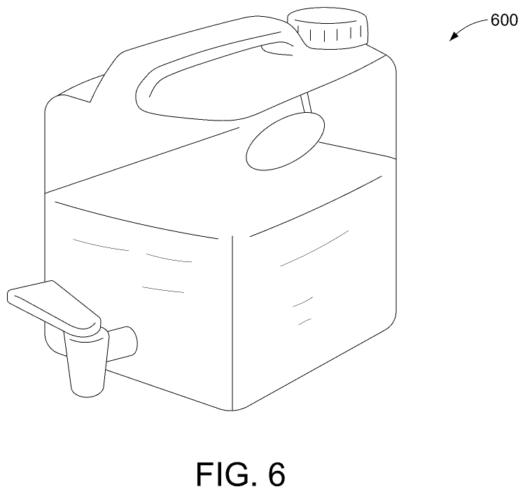

FIG. 6 is a perspective view of a water storage dispenser 600, in accordance with at least one embodiment. The water storage dispenser 600 is configured for the convenient dispensing of purified water directly into a container for drinking. In an embodiment, the water storage dispenser 600 is integrated into the RV's kitchen or living area, allowing for convenient access to purified drinking water.

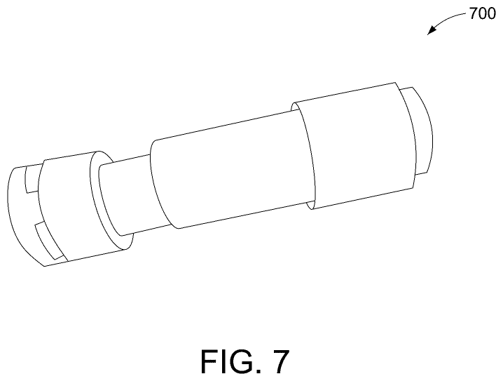

FIG. 7 is a perspective view of a flow restrictor 700, in accordance with at least one embodiment. The flow restrictor 700 is configured to regulate and slow the outflow of water exiting the RO water filtration system via a waste line, optimizing the efficiency of the filtration process. In an embodiment, the flow restrictor 700 is adjustable and enables users to fine-tune the wastewater output to optimize water conservation during the filtration process.

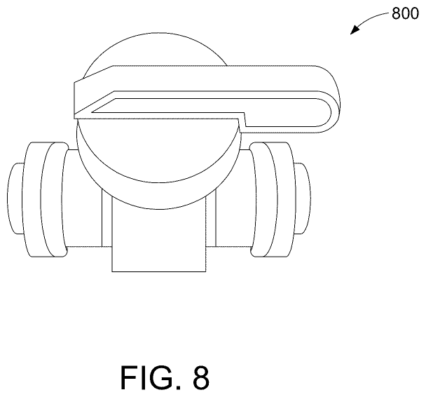

FIG. 8 is a perspective view of a water line shut-off valve 800, in accordance with at least one embodiment. The water line shut-off valve 800 is configured to provide control over the flow of water into or out of the RO manifold 100 on a specific water line. In an embodiment, the water line shut-off valve 800 is a manual valve that allows for the selective control of water flow to specific components within the RO system, such as the storage tank or dispenser.

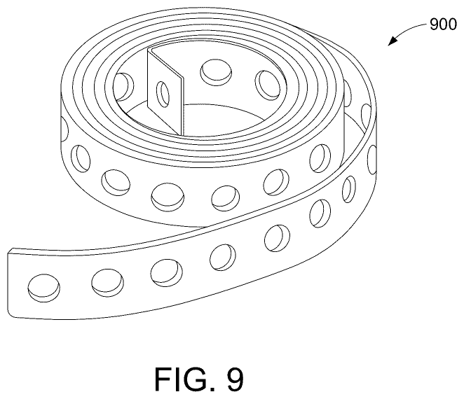

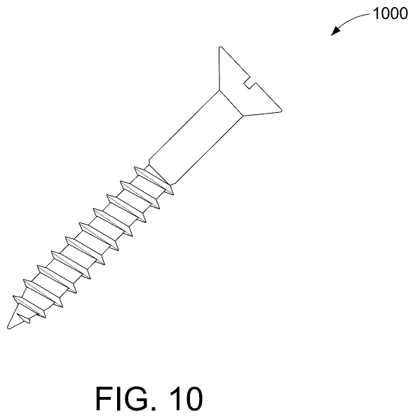

FIG. 9 is a perspective view of a security strap 900, in accordance with at least one embodiment. The security strap 900 is used to secure the RO system components, such as the water storage tank and manifold, in place within the RV. The security strap 900 prevents the components from shifting, moving, or vibrating excessively while the RV is in motion, which could lead to damage or disconnections. The security strap 900 helps reduce vibrations and shocks during travel, which can prolong the lifespan of the RO system components by preventing wear and tear. FIG. 10 is a perspective view of a screw 1000, in accordance with at least one embodiment. The screws 1000 are used to securely attach the RO system components, such as the manifold, water storage tank, or tubing brackets, to the walls or floor of the RV. The screw 1000 ensures that the system is firmly fixed in place, preventing movement or dislodgement. The screws 1000 provide structural support to the RO system, ensuring that all parts remain securely connected and aligned, which is critical for the system to function correctly and efficiently. By securing the RO system components with screws, the risk of leaks, disconnections, or component failures is minimized, enhancing the safety of the system and the RV occupants.

Reverse osmosis (RO) systems have traditionally been difficult, if not impossible, to install in an RV or motorhome. However, with the present invention, this challenge has been successfully addressed. The present reverse osmosis (RO) water filtration system provides high-quality drinking water in RVs and motorhomes, which remains an underdeveloped area in the reverse osmosis industry. Further, the present invention offers a complete Water Station, with the option to route purified RO water directly to the RV kitchen cabinet, allowing you to fill containers with the purest drinking water available. The system includes specially designed water containers with an automatic shut-off feature, enabling you to transport the filled containers inside your motorhome. Additionally, you have the flexibility to route the water to your kitchen cabinet or even to your RV's fresh water tank.

According to an embodiment herein, the patentable aspects of the present invention lie in the way it connects the RO filter to the RV's water inlet. Using a two-way hose splitter with a valve, the system reduces a ¾″ garden hose fitting to a ¼″ reverse osmosis size, perfectly feeding the RV RO system.

The present invention enables the production of exceptionally pure water from a reverse osmosis system at an affordable price, making it accessible to motorhome and RV owners. Previously, installing a reverse osmosis system in an RV was nearly impossible due to the high water pressure requirements and other installation complexities, typically only found in houses or apartments with proper drainage.

In implementation, the present invention includes easy-to-follow instructions for connecting the RO system to your RV's fresh water tank, allowing you to enjoy not just drinking water but also pure, soft, crystal-clear water for bathing and general use from any faucet in your RV or motorhome. Installation is incredibly straightforward, taking just 20 minutes. Simply connect the water and four hoses to enjoy pure water anytime, anywhere.

The RV RO Water Station provided by the present system is the most convenient way to enjoy pure water, whether at home, in a temporary setup, or locations such as construction sites, military camps, or any place with access to potable water but not necessarily pure drinking water. The system features an easy cartridge replacement process e.g. just a quick twist of the old cartridge and insertion of the new one, without the need to remove the entire unit from your kitchen cabinet, unlike most units currently on the market. Further, the cartridges of the present system can also be easily replaced by using a sediment filter, a carbon block quick-twist filter, a membrane quick-twist filter, and a post-carbon quick-twist filter.

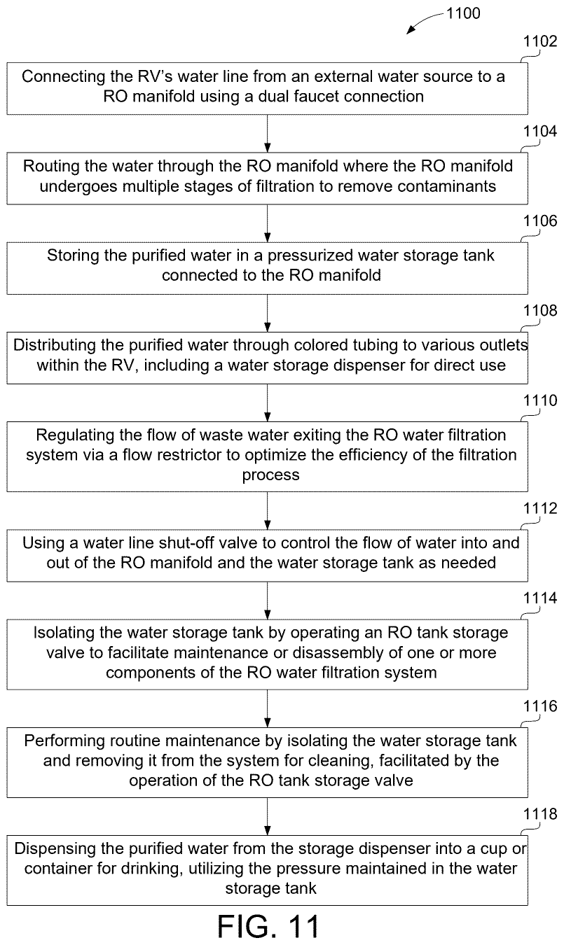

FIG. 11 is a flowchart of a method 1100 for purifying water in a recreational vehicle (RV) using a reverse osmosis (RO) water filtration system, in accordance with at least one embodiment. The method 1100 includes a step 1102 of connecting the RV's water line from an external water source to an RO manifold using a dual faucet connection. In an embodiment, the step of connecting the RV's water line includes a step of using a quick connect adaptor to simplify the connection and disconnection process. The method 1100 includes a step 1104 of routing the water through the RO manifold where the RO manifold undergoes multiple stages of filtration to remove contaminants. The method 1100 includes a step 1106 of storing the purified water in a pressurized water storage tank connected to the RO manifold. The method 1100 includes a step 1108 of distributing the purified water through colored tubing to various outlets within the RV, including a water storage dispenser for direct use. The method 1100 includes a step 1110 of regulating the flow of wastewater exiting the RO water filtration system via a flow restrictor to optimize the efficiency of the filtration process. In an embodiment, the regulation of the wastewater flow via the flow restrictor includes adjusting the flow restrictor to balance water conservation with optimal filtration performance. The method 1100 includes a step 1112 of using a water line shut-off valve to control the flow of water into and out of the RO manifold and the water storage tank as needed. Method 1100 includes a step 1114 of isolating the water storage tank by operating an RO tank storage valve to facilitate maintenance or disassembly of one or more components of the RO water filtration system. In an embodiment, the method 1100 includes a step 1116 of performing routine maintenance by isolating the water storage tank and removing it from the system for cleaning, facilitated by the operation of the RO tank storage valve. In an embodiment, method 1100 includes a step 1118 of dispensing the purified water from the storage dispenser into a cup or container for drinking, utilizing the pressure maintained in the water storage tank.

According to an embodiment herein, the present invention provides a method for purifying water in a recreational vehicle (RV) using a reverse osmosis (RO) water filtration system. The method includes a step of selecting a storage compartment on the driver's side of the motor home or the left side of the trailer, which houses the water, sewage, and electricity connections. The method includes a step of connecting the RV RO system to the RV camp water faucet using a splitter, wherein the splitter separates the water supply into two streams: one feeding the entire RV and one feeding the RV RO system. The method includes a step of connecting a white hose, designated as the inlet, to the first port of the RO system to supply water. The method includes a step of connecting a black hose to the second port, designated as the drain port, for discharging wastewater from the RO system. The method includes a step of connecting a yellow hose to the third port, which is configured to connect to the RO water storage tank. The method includes a step of connecting a blue hose to the fourth port, which is configured to dispense purified water into a designated water container. The method includes a step of placing the water container inside the RV and using the purified water produced by the RO system for drinking and other purposes. In an embodiment, the step of selecting the storage compartment includes ensuring that the compartment has sufficient space to accommodate the RO system and provides easy access to the necessary water, sewage, and electrical connections. In an embodiment, the step of connecting the RV RO system to the camp water faucet includes ensuring that the water pressure is compatible with the RO system requirements. The method further includes the step of checking all hose connections for leaks after setup to ensure the system operates efficiently without water loss. In an embodiment, the step of using the purified water includes storing the water container in a designated space within the RV for easy access and ensuring that the water remains clean and uncontaminated.

A person skilled in the art will understand that the reverse osmosis (RO) water filtration system for recreational vehicles (RVs) and the method of water purification and dispensation are described herein for illustrative purposes and should not be construed to limit the scope of the disclosure.

A person with ordinary skills in the art will appreciate that the systems and methods have been illustrated and explained to serve as examples and should not be considered limiting in any manner. It will be further appreciated that the variants of the above-disclosed system elements, modules, and other features and functions, or alternatives thereof, may be combined to create other different apparatuses, systems, or applications.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

I claim:

1. A reverse osmosis (RO) water filtration system for use with a recreational vehicle (RV), comprising:
a RO manifold configured as a base unit housing a plurality of multiple filtration stages of a reverse osmosis process and dispensing purified water to one or more components of the RO water filtration system;
a dual faucet connection configured to connect the RV's water line from an external site's water source to the RO manifold;
a water storage tank configured to store water purified by the RO manifold and pressurize the RO manifold for rapid dispensing;
a colored tubing configured to provide distinct channels for distributing and receiving water from and to the components of the RO water filtration system;
a RO tank storage valve configured to allow the water storage tank to be isolated from the RO water filtration system for disassembly or maintenance;
a quick connect adaptor configured to facilitate the connection of the water line from the RO water filtration system to the dual faucet connection;
a water storage dispenser configured for the convenient dispensing of purified water directly into a container for drinking;
a flow restrictor configured to regulate and slow the outflow of water exiting the RO water filtration system via a waste line, optimizing the efficiency of the filtration process; and
a water line shut-off valve configured to provide control over the flow of water into or out of the RO manifold on a specific water line.

2. The RO water filtration system according to claim 1, wherein the RO manifold includes multiple filtration stages, each configured to remove specific types of contaminants from the water, including sediments, chlorine, and dissolved solids.

3. The RO water filtration system according to claim 1, wherein the water storage tank is pressurized to maintain a constant supply of purified water for immediate use without requiring additional pumping.

4. The RO water filtration system according to claim 1, wherein the colored tubing includes color-coded connections to simplify the installation and maintenance process by clearly indicating the pathways for water inflow, purified water outflow, and wastewater exit.

5. The RO water filtration system according to claim 1, wherein the RO tank storage valve is configured to be manually operated, allowing users to easily isolate the water storage tank for maintenance or disassembly.

6. The RO water filtration system according to claim 1, wherein the quick connect adaptor is designed for tool-free connection and disconnection of the water lines, enhancing the ease of setup and use within the RV environment.

7. The RO water filtration system according to claim 1, wherein the water storage dispenser is integrated into the RV's kitchen or living area, allowing for convenient access to purified drinking water.

8. The RO water filtration system according to claim 1, wherein the flow restrictor is adjustable, enables users to fine-tune the wastewater output to optimize water conservation during the filtration process.

9. The RO water filtration system according to claim 1, wherein the water line shut-off valve is a manual valve that allows for the selective control of water flow to specific components within the RO system, such as the storage tank or dispenser.

10. A method for purifying water in a recreational vehicle (RV) using a reverse osmosis (RO) water filtration system, comprising:
connecting the RV's water line from an external water source to a RO manifold using a dual faucet connection;
routing the water through the RO manifold where the RO manifold undergoes multiple stages of filtration to remove contaminants;
storing the purified water in a pressurized water storage tank connected to the RO manifold;
distributing the purified water through colored tubing to various outlets within the RV, including a water storage dispenser for direct use;
regulating the flow of wastewater exiting the RO water filtration system via a flow restrictor to optimize the efficiency of the filtration process;
using a water line shut-off valve to control the flow of water into and out of the RO manifold and the water storage tank as needed; and
isolating the water storage tank by operating an RO tank storage valve to facilitate maintenance or disassembly of one or more components of the RO water filtration system.

11. The method according to claim 10, wherein the step of connecting the RV's water line includes using a quick connect adaptor to simplify the connection and disconnection process.

12. The method according to claim 10, further comprises performing routine maintenance by isolating the water storage tank and removing it from the system for cleaning, facilitated by the operation of the RO tank storage valve.

13. The method according to claim 10, wherein the regulation of the wastewater flow via the flow restrictor includes adjusting the flow restrictor to balance water conservation with optimal filtration performance.

14. The method according to claim 10, further comprises dispensing the purified water from the storage dispenser into a cup or container for drinking, utilizing the pressure maintained in the water storage tank.
